(19) United States
(12) Patent Application Publication
(10) Pub. No.: US 2022/0134371 A1
(43) Pub. Date: May 5, 2022

(54) FILTER MODULE AND TRAP FOR TRAPPING OVERSPRAY, COATING FACILITY AND METHOD FOR OPERATING A COATING FACILITY

(71) Applicant: EISENMANN GMBH, Böblingen (DE)

(72) Inventors: Norman POBOSS, Böblingen (DE); Johann HALBARTSCHLAGER, Holzgerlingen (DE); Marco KLOTZ, Althengstett (DE)

(21) Appl. No.: 17/435,324

(22) PCT Filed: Feb. 28, 2020
(86) PCT No.: PCT/EP2020/055316

§ 371 Date: Aug. 31, 2021

(30) Foreign Application Priority Data
Mar. 1, 2019 (DE) 10 2019 105 256.4

(51) Int. Cl. B05B 14/43; B05D 3/02; B05D 1/02; B01D 46/16; B01D 46/62; B01D 46/00; B01D 46/88; B01D 46/84; B01D 46/48; B01D 39/12

(52) U.S. Cl. CPC B05B 14/43; B05D 3/0254; B05D 1/02; B01D 46/16; B01D 46/62; B01D 2239/0618; B01D 46/88; B01D 46/84; B01D 46/48; B01D 39/12; B01D 46/0005; B01D 46/0013

(57) ABSTRACT

The invention relates to a filter module for trapping overspray from booth air laden with overspray from coating facilities, particularly from painting facilities, having a module housing, in which a filter structure (88) is accommodated and which has a module inlet (74) and a module outlet (76), wherein the filter module (40) is designed in such a manner that it is swapped for an empty filter module (40) once a limit loading of overspray is reached. The filter module (40) comprises a recyclable reusable structure (112) of one or more reusable components that can be thermally regenerated and therefore the filter module (40) can at least partially be thermally regenerated. The invention also relates to a trap having one or more filter modules of this kind, a coating facility for coating objects (14) and to a method for operating a coating facility.

The invention relates to a filter module for separating overspray from overspray-laden booth air of coating facilities, in particular of painting facilities, having a module housing in which a filter structure is accommodated and which has a module inlet and a module outlet, wherein the filter module is designed in such a way that, after reaching a limit loading with overspray, it is exchanged for an empty filter module.

In addition, the invention relates to a separating apparatus for separating overspray from overspray-laden booth air of coating facilities, in particular painting facilities, having at least one filter module through which overspray-laden booth air can be channeled and in which overspray is separated.

Moreover, the invention relates to a coating facility for coating, in particular for painting, objects, in particular vehicle bodies, having
a) at least one coating booth in which the objects can have coating material applied to them and through which an air flow can be channeled which receives and removes occurring overspray of the coating material;
b) a separating apparatus to which this air flow can be fed and where a large part at least of the solids is separated from the overspray.

Furthermore, the invention also relates to a method for operating a coating facility for coating, in particular for painting, objects, in particular vehicle bodies, wherein overspray occurs from coating material, in which the overspray is received by an air flow and is guided to a separating apparatus in the form of one or more filter modules in which a large part at least of the solids is separated from the overspray, wherein each filter module, after reaching a limit loading with overspray, is exchanged for an empty filter module.

During the manual or automatic application of paints to objects, a subflow of the paint, which generally contains not only solids and/or binders but also solvents, is not applied to the object. This subflow is referred to as “overspray” by those skilled in the art. Furthermore, the term overspray is always understood in the sense of a disperse system, such as an emulsion or suspension or a combination thereof. The overspray is captured by the air flow in the painting booth and fed for separation, with the result that the air, possibly after suitable conditioning, can be channeled back again into the coating booth.

DE 10 2011 108 631 A1 discloses operating with exchangeable disposable filter modules which, after reaching a limit loading with overspray, are exchanged for unladen filter modules and are disposed of or possibly recycled. The processing and/or disposable of such filter modules can be more energy-compatible and also more compatible in terms of the required resources as compared with the cost and complexity involved in other separating concepts, such as, for example, wet separators known on the market or electrostatically operating separating apparatuses.

Nevertheless, it is the object of the invention to improve the energy and resource effectiveness in relation to the separation of overspray.

This object is achieved, in a filter module of the type stated at the outset, in that the filter module comprises a recyclable reusable structure composed of one or more thermally regenerable reusable components, with the result that the filter module is at least partially thermally regenerable.

According to the invention, it has been recognized that, by means of such filter modules, the complexity and the costs for the disposal of a respective filter module can be considerably reduced, with it being the case here, however, that the otherwise very effective and operationally reliable separating concept with exchangeable filter modules can be pursued further. Filter modules according to the invention can also be used subsequently in existing coating facilities which operate with exchangeable filter modules.

What is to be understood by a thermally regenerable reusable component is a component which withstands, at least once and preferably repeatedly, a thermal treatment in which present overspray is thermally decomposed and thereby removed from the filter module without losses in its functional capability. This will be discussed again in more detail further below.

In one variant, the filter module can be completely thermally regenerable. However, it is also advantageous if the filter module comprises a disposable structure composed of one or more thermally decomposable disposable components. By contrast with a thermally regenerable reusable component, a thermally decomposable disposable component is likewise decomposed in a thermal treatment in which present overspray is thermally decomposed, with the result that, after the thermal treatment, only the reusable structure of the filter module remains behind.

In this context, one or more thermally regenerable reusable components or one or more thermally decomposable disposable components are advantageously present from the following group:
a) the module housing as a whole or a housing frame structure of the module housing and/or one or more housing wall segments of the module housing;
b) a collecting trough for coating material which is separated in the filter module and flows off downwardly;
c) the filter structure as a whole or one or more filter elements of the filter structure, in particular one or more nonwoven mats of the filter structure;
d) a filter carrier structure as a whole for the filter structure or a carrier plate for filter elements of the filter carrier structure and/or at least one supporting wall of the filter carrier structure and/or a receiving framework for receiving a filter device which comprises the filter structure;
e) the filter device as a whole or a filter housing of the filter device.

An effective thermal treatment and decomposition of the overspray and of the components can occur if one or more thermally decomposable disposable components are produced from one or more of the following materials: cellulose material, in particular possibly treated paper and paperboard material, corrugated cardboard, cardboard with vertical corrugation, cardboard with a honeycomb structure or wrap around cardboard, wood; MDF material; plastics material, in particular polyethylene or polypropylene.

With regard to the resistance of the recyclable reusable structure to a thermal treatment, it is favorably if one or more thermally regenerable reusable components are produced from one or more of the following materials: metal or metal alloy, in particular stainless steel, steel or steel sheet; ceramic material.

The aforementioned object is achieved, in a separating apparatus of the type stated at the outset, in that the at least one filter module is a filter module having some or all of the above-explained features.

In a coating facility of the type stated at the outset, the aforementioned object is achieved in that the separating apparatus is formed in this way.

If in the coating facility there is present a thermal treatment apparatus, in particular a pyrolysis oven in which one or more laden filter modules can be thermally treated in such a way that overspray is thermally decomposed, the thermal treatment and the recovery of the reusable structure can occur in situ at the operating site of the coating facility. As a result, in particular transport costs are kept low.

In a method of the type stated at the outset, the aforementioned object is achieved in that use is made of one or more filter modules having some or all of the features explained in connection with the filter module, wherein a filter module, after reaching its limit loading with overspray as laden filter module, is subjected, in a thermal treatment apparatus, to a thermal treatment in which the overspray is thermally decomposed.

The thermal treatment apparatus can, as specified above, be present at the operating site of the coating facility or at another site. If the thermal treatment apparatus is not provided at the site of the coating facility, a thermal treatment apparatus can be supplied, in particular with laden filter modules, from surrounding coating facilities as collection point.

In the above sense, it can be advantageous if use is made of one or more filter modules having a disposable structure which is thermally decomposed during the thermal treatment, wherein the reusable structure remaining after the thermal treatment is then completed again with a disposable structure to form a filter module which is used thereafter for separating overspray.

An effective thermal treatment can be carried out by the laden filter module being exposed to a temperature between 200° C. and 1500° C., preferably between 300° C. and 900° C., more preferably between 400° C. and 900° C. and particularly preferably between 400° C. and 600° C.

It is particularly advantageous here if the thermal treatment is a pyrolysis which is carried out in a pyrolysis oven and in particular with a separate supply of oxygen, wherein a pyrolysis gas occurs.

During the thermal treatment there occurs a hot exhaust gas which is advantageously used as a heat source for a secondary device or for power generation.

The secondary device is preferably a drier in which the coating objects are dried and which comprises a heat exchanger to which the exhaust gas is fed. Alternatively or additionally, the pyrolysis gas can be fed for energy generation to a combined heat and power plant.

It is advantageous in terms of energy if the thermal energy obtained during the thermal treatment is stored in an energy store and is possibly subsequently used in an ORC plant.

Likewise advantageously, the energy of exhaust gas can be used for power generation, for which purpose the exhaust gas is fed in particular to an ORC plant.

Exemplary embodiments of the invention will be explained in more detail below with reference to the drawings, in which:

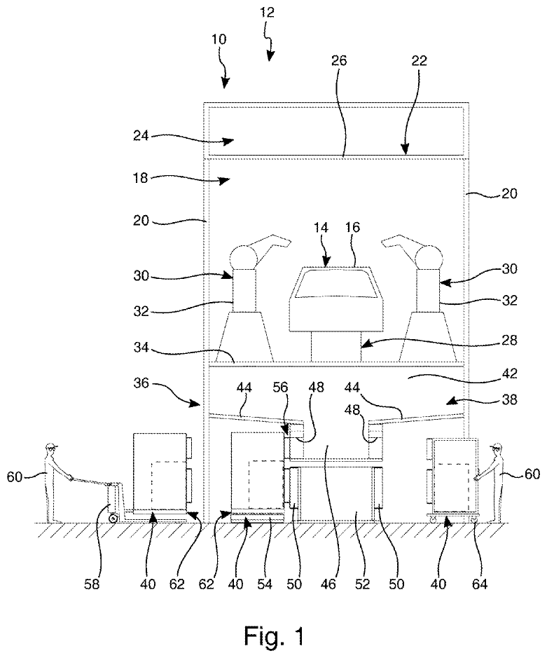

FIG. 1 shows a front view of a painting booth of a coating facility having a separating apparatus for overspray having exchangeable and at least partially thermally regenerative filter modules, of which two exemplary embodiments are schematically illustrated;

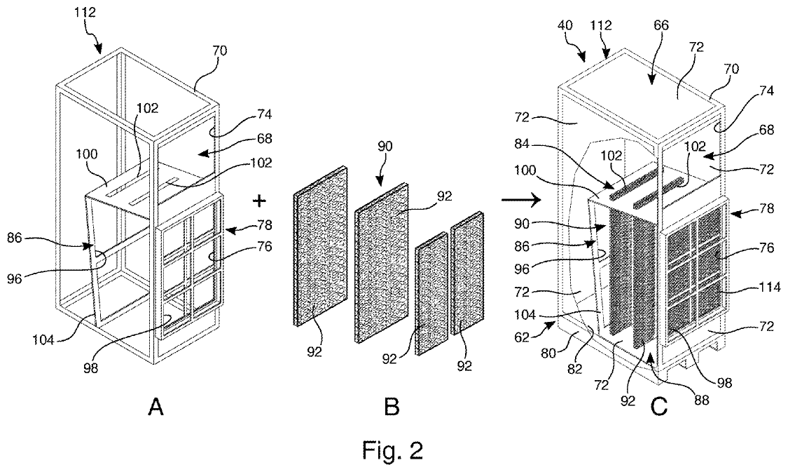

FIG. 2 shows the conceptional design of a filter module according to the first exemplary embodiment having a module housing and a filter unit accommodated therein;

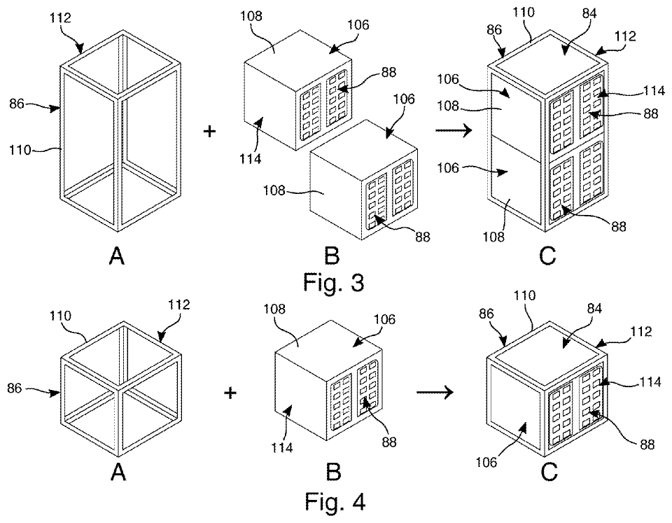

FIG. 3 shows a first modification of the filter unit;

FIG. 4 shows a second modification of the filter unit;

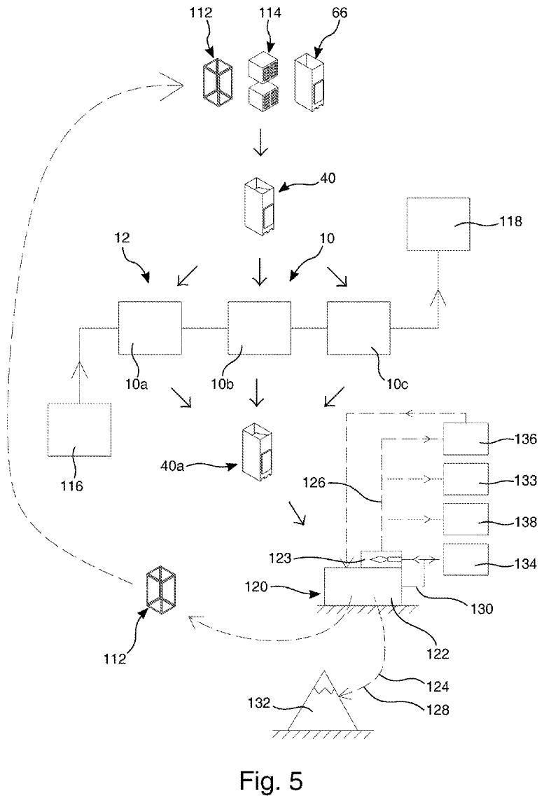

FIG. 5 shows an overview diagram in which the use of the filter modules whose partial regeneration and ways of energy use are illustrated using the example of a painting facility.

FIG. 1 shows a coating booth 10 of a coating facility designated overall by 12, in which objects 14 have a coating material, in particular a paint, applied to them. A vehicle body 16 is shown as an example of objects 14 to be painted. Before vehicle bodies 16 reach such a coating booth 10, they are usually, for example, cleaned and degreased in pretreatment stations by a dip method.

The coating booth 10 comprises a coating tunnel 18 which is delimited by side walls 20 and a booth ceiling 22, but is open at the end sides. Moreover, the painting tunnel 18 is opened downwardly in such a way that overspray-laden booth exhaust air can flow downwardly. The booth ceiling 22 defines a lower limit of an air supply space 24 and takes the form of a filter ceiling 26.

The vehicle bodies 16 are transported from the inlet side of the coating tunnel 18 to its outlet side by means of a conveying system 28 which is known per se. In the interior of the coating tunnel 18 there are situated application devices 30 in the form of multi-axis application robots 32, as are likewise known per se. The vehicle bodies 16 are coated with the corresponding material by means of the application robots 32. Alternatively or in addition, a manual application of the material by workers can be carried out for this purpose.

An air flow, which receives and removes occurring overspray of the coating material, can be channeled through the coating booth 10.

For this purpose, during the coating operation, booth air flows out of the air supply space 24 downwardly through the coating tunnel 18 and in so doing receives the paint overspray occurring during the application and entrains it further downward.

In the downward direction, the coating tunnel 18 is opened, via a walk-on grating 34, to a facility region 36 which is arranged below and in which the overspray entrained by the booth air is separated from the booth air.

This overspray-laden air flow is channeled, by means of an air-channeling device 38, to a separating apparatus in the form of one or more filter modules 40 in which a large part at least of the solids is separated from the overspray. For this purpose, in the present exemplary embodiment, the air-channeling device 38 comprises a guiding channel 42 which is formed by means of baffles 44 which extend inwardly and with a downward inclination from the side walls 20. The baffles 44 can also run horizontally. The guiding channel 42 opens at the bottom into a plurality of connection channels 46 with connection openings 48. In FIG. 1 there can be seen only one connection channel 46; in practice, there are successively arranged, in a direction perpendicular to the paper plane of FIG. 1, a plurality of such connection channels 46 which can each be connected to the filter modules 40.

FIG. 1 illustrates an exemplary embodiment in which the connection channels each have two connection openings 48 which are situated opposite in the direction transversely with respect to the transport direction of the vehicle bodies 16. In this case, in each case two filter modules can be connected, on the opposite sides of the connection channel 46, to the air-channeling device 38.

During operation, each filter module 40 is fluidically and releasably connected to the air-channeling device 38. The booth air flows, in the filter module 40, through a filter unit which is indicated by dashed lines and on or in which the paint overspray is separated. This will be discussed again further below. Overall, each filter module 40 takes the form of an exchangeable structural unit.

After leaving a filter module 40, the booth air is now largely freed from overspray particles and flows from the filter modules 40 into an intermediate channel 50 via which it passes into a collecting flow channel 52.

The booth air is fed, via the collecting flow channel 52, for further processing and conditioning and subsequently channeled, in a circuit (not specifically shown here) back into the air supply space 24 from which it flows again from above into the coating tunnel 18.

If the booth air is not yet sufficiently freed of overspray particles by means of the present filter modules 40, it is possible for there to be arranged downstream of the filter modules 40 yet further filter stages to which the booth air is fed and in which, for example, there are also used electrostatically operating separators as are known per se.

Each filter module 40 is designed to receive a maximum amount of paint, that is to say for a limit loading with overspray, which depends on the type of filter module 40 and the materials used therefor. The already received amount of paint can be monitored via a weigher 54 which is illustrated in FIG. 1 in the filter module 40 shown there on the left. Alternatively, the limit loading can be ascertained by means of differential pressure determination. The greater the loading of the filter module 40, the greater the air resistance brought up by the filter module 40.

During operation, each filter module 40 is arrested in its operating position by means of a locking device 56, which is only indicated schematically. If a filter module 40 reaches its maximum receiving capacity, this locking device 56 is released and the fully laden filter module 46 is moved out of the lower facility region 36 of the coating booth 10. This can be achieved, for example, by means of a lifting trolley 58 which is operated by a worker 60. As is illustrated by way of the filter modules 40 shown on the left in FIG. 1, it is possible for this purpose for a bottom region 62 of the filter modules 40 to be designed in its geometry and its dimensions as a standardized supporting structure and, for example, according to the specification of a so-called Euro Palette.

On the right side of FIG. 1 there is shown, as modification, a filter module 40 in which the bottom region 62 is provided with running rollers 64. Such a filter module 40 can be moved by a worker 60 without an additional lifting device.

If a filter module 40 reaches its limit loading with overspray, it is exchanged for an empty filter module 40, that is to say one not laden with overspray. Before a laden filter module 40 is exchanged for an empty filter module 40, the flow connection of the filter module 40, which is to be exchanged, with the air-channeling device is closed by means of blocking devices (not shown specifically), for example by means of a respective blocking slide. The blocking device diverts the booth air to the filter modules 40 which are arranged next to the filter module 40 to be exchanged and which perform the task thereof until the exchange has been carried out.

An empty filter module 40 is then pushed into the operating position in which it is connected to the air-channeling device 38 in a flow-tight manner, whereupon the locking device 56 is arrested again. The blocking slide of the air-channeling device 38 is brought into an open position again such that the booth air flows through the newly positioned filter module 40.

In a modification, which is not shown specifically, the exchange of a filter module 40 can also occur in an automated or at least semi-automated manner. For this purpose, the filter modules 40 which are arranged next to one another can have a conveying system present upstream thereof which can convey the filter modules 40 to be exchanged to one or more removal points where they can be removed by a worker 60. At one or more loading points, an empty filter module 40 can then be transferred to the conveying system which then conveys this empty filter module 40 to the location in the facility region 36 where the full filter module 40 has been removed.

In what follows, the basic construction of a filter module 40 will now first of all be explained on the basis of FIG. 2 using the subfigures A, B and C; a complete filter module 40 can be seen there only on the far right in subfigure C.

A filter module 40 comprises a module housing 66 which delimits a flow chamber 68. The module housing 66 has a housing frame structure 70 which for its part bears housing wall segments 72 which delimit the flow chamber 68. If housing wall segments 72 are connected to one another in a self-supporting manner, it is possible to dispense with a corresponding housing frame structure. In phase C of FIG. 2, there is shown a wall segment 72 in cut-away form, with the result that the flow chamber 68 can be seen. The flow chamber 68 extends between a module inlet 74 and a module outlet 76 which are both provided on a connection side 78 of the module housing 66 that correspondingly serves both as an inlet side for the overspray-laden booth air and as the outlet side for the cleaned booth air.

The positions of the module inlet 74 and of the module outlet 76 of the filter module 40 are designed to be complementary to the air-channeling device 30—here specifically to the connection channels 46—or complementary to the connecting flow channel 52—here specifically to a respective intermediate channel 50. In this way, the module inlet 74 can be fluidically connected to the air-channeling device 38, and the module outlet 76 can be fluidically connected to the collecting flow channel 52.

The filter module 40 shown in FIG. 2C corresponds to the filter modules 40 shown on the left in FIG. 1; here, the module housing 66 is carried by a bottom part 80 which, in the present exemplary embodiment, is formed in its geometry and its dimensions as a standardized supporting structure and, for example, according to the specification of a Euro Palette already mentioned above.

In the modification shown on the right in FIG. 1, the bottom part 80 can be formed, for example, as a supporting frame into which the module housing 66 is inserted and to which the rolling rollers 64 are fastened.

At least one lower collecting region of the filter module 40 is designed to be liquid-tight and in this way as a collecting trough 82 for coating material which is separated in the filter module 40 and flows off downwardly. Such a collecting trough 82 can also be provided as a separate component.

In the flow chamber 68 there is arranged a filter unit which has already been discussed above and also designated by 84 in FIG. 1 and which comprises a filter carrier structure 86 for a filter structure 88. In the exemplary embodiment shown in FIG. 2, the filter structure 88 comprises a plurality of filter elements 90 in the form of nonwoven mats 92 with different dimensions which are arranged behind one another through the filter unit 84 in the flow direction and are held by the filter carrier structure 86.

The filter structure 88 is arranged in a filter space 94 which is defined by the filter carrier structure 86 and into which the overspray-laden booth air can flow through a flow inlet 96 of the filter unit 84 and out of which the then filtered booth air can flow via a flow outlet 98 which leads to the module outlet 76 of the filter module 40. For this purpose, in the present exemplary embodiment, the filter carrier structure 86 has an upper carrier plate 100 with holding slots 102 for the nonwoven mats 92.

Supporting walls 104 descend downward to the bottom of the module housing 66 from the carrier plate 100 on opposite sides and have the flow inlet 96 and the flow outlet 98 formed therein. The filter unit 84 is open on the flanks with respect to the flow direction, with the result that the filter space 94 in the filter module 40 is delimited, on the one hand, by the filter carrier structure 86 and, on the other hand, by the flanking regions of housing wall segments 72 of the module housing 66.

The nonwoven mats 92 illustrate only by way of example one possible variant of a filter structure 88. The filter structure 88 can also comprise other parts which provide for overspray to be separated in the filter module 40. This can also be achieved, for example, by means of foams, knits, grids, lamellae, channels, struts, nets, mats and the like, as is known per se.

FIGS. 3 and 4 illustrate modified filter units 84, wherein components and structural parts which already functionally correspond to components and structural parts explained for FIG. 2 bear the same reference signs. The filter units 84 shown in FIGS. 3 and 4 can be provided in a filter module 40 instead of the filter unit 84 shown in FIG. 2.

In the exemplary embodiments shown in FIGS. 3 and 4 by way of the respective subfigures A, B and C, the filter structure 88 is in each case accommodated in separate filter devices 106 which have a dedicated filter housing 108 through which flow can pass. The latter correspondingly has an inlet side and an outlet side which are not indicated separately.

The filter carrier structure 86 is designed to be complementary to one or more filter devices 106. In the present exemplary embodiments, this filter carrier structure 86 is, in FIG. 3, designed by way of example as a receiving framework 110 for two filter devices 106 and, in FIG. 4, designed by way of example as a receiving framework 110 for a single filter device 106; where appropriate, it is then possible for two such filter carrier structures 86 each having a filter device 106 to be used as an assembly and to form a filter unit 84. In each case two or one filter device(s) 106 can be pushed into the receiving framework 110 or introduced in some other way.

The filter structure 88 can again be formed by flow-traversable filter elements 90, for example nonwoven mats 92, of which, in subfigure 2C, only one bears a reference sign. There can also be present a cardboard structure or other above-explained parts which provide for overspray to be separated in the filter module 40. In the filter housing 108, the filter structure 88 can form a flow labyrinth by means of flow-tight filter elements 90, with the result that the mode of operation of an inertia filter as an alternative or as an addition to the mode of operation of a separating filter, in which flow-traversable filter elements 90 are present, can be used in the filter unit 84. In a corresponding manner, in the exemplary embodiment according to FIG. 2, too, correspondingly flow-tight filter elements 90 can be present as an alternative or as an addition to the nonwoven mats 92 shown there.

In the filter modules 40 illustrated by way of FIGS. 2 to 4, the booth air flows on the connection side 78 through the module inlet 74 into the flow chamber 68, is deflected there through 180° and guided through the flow inlet 96 of the filter unit 84.

In modifications, which are not shown specifically, the module inlet 74 and/or the module outlet 76 can also be provided on different sides of the filter module 40 and then each define a separate inlet side or a separate outlet side of the filter module 40. For example, the module inlet 74 can be provided at the top of the filter module 40 or on that side of the filter module 40 situated opposite to the module outlet 76. In such modifications of the filter modules 40, the air-channeling device 38 and the collecting flow channel 52 or the associated connection channels 46 and intermediate channels 50 are modified in a corresponding complementary manner in their arrangements and dimensions. In these cases, the booth air, after flowing into the filter module 40, is not deflected through 180° before it flows into the filter unit 84, but is possibly only deflected through 90° or not at all.

The filter carrier structure 86 shown in FIG. 3C can, where appropriate, together with the filter devices 106 with which it is equipped, serve as a filter module 40. Where appropriate, the assembly consisting of receiving framework 110 and filter devices 106 is placed as a module housing 66 onto a bottom part 80; the opposite sides of the filter devices 106 then define the module inlet 74 and the module outlet 76. For such a filter module 40, the air-channeling device 38 of the coating booth 10 has to be correspondingly modified. The same applies analogously to the receiving framework 110, which is equipped with only one filter device 106, according to FIG. 4C.

The type of coating material with which the objects 14 in the coating booth 10 are coated can be different or can change for different objects 14 or for different process sequences or phases. Depending on the applied coating material, different types of overspray also occur.

Depending on the type and the properties of the occurring overspray, it is also possible for the requirements placed on filter modules 40 used to be different in order to display an effective filter action tailored to the respective type of overspray.

Thus, depending on the type and the properties of the occurring overspray, filter modules 40 having a filter structure 88 adapted to the type of overspray can be used for effective separation of the overspray.

The filter module 40 is designed in such a way that it can be subjected to a thermal treatment in which the received overspray is thermally decomposed. Different types of possible thermal treatments will be discussed in more detail further below in connection with FIG. 5.

The filter module 40 comprises a recyclable reusable structure, designated generally by 112, composed of one or more thermally regenerable reusable components, with the result that a filter module 40, in particular an overspray-laden filter module 40, is at least partially thermally regenerable. What is to be understood by recycling here is a renewed and possibly repeated use of the reusable structure 112 in the context of its original function.

As explained at the outset, what is to be understood by a thermally regenerable reusable component is a component which withstands, at least once and preferably repeatedly, a thermal treatment, in which present overspray is thermally decomposed and thereby removed from the filter module 40, without losses in its functioning capability.

These are, on the one hand, components which, prior to the thermal treatment, can no longer perform their function and are functionally regenerated by the thermal treatment, with the result that they can perform their original function again. An example of this that may be mentioned is a filter element 90 which is laden with overspray to saturation and which consists of a metal nonwoven which no longer achieves a useful filter action or blocks the passage of flow through the filter module 40. During a thermal treatment, the overspray is decomposed and the metal nonwoven is cleaned of the overspray and remains cleaned in the filter module 40, with the result that it can again achieve its original filter action.

On the other hand, components which, prior to the thermal treatment, satisfactorily perform their function can also define such thermally regenerable reusable components. An example of such a reusable component that may be mentioned is a housing strut or the like, for example consisting of stainless steel, which, without functional impairment, withstands a thermal treatment in which the decomposable disposable components are decomposed.

Here, in one exemplary embodiment, the filter module 40 can be completely thermally regenerable. In this case, all the components from which the filter module 40 is built up are thus thermally regenerable reusable components, and the recyclable reusable structure 112 defines the filter module 40 as such.

In a modification, the filter module 40 can comprise, in addition to the recyclable reusable structure 112, a disposable structure, designated generally by 114, consisting of one or more thermally decomposable disposable components, with the result that the filter module is partially thermally regenerable. In this case, the filter module 40 is thus built up from the recyclable reusable structure 112 and the disposable structure 114.

As has also already been explained at the outset, a thermally decomposable disposable component is, by contrast with a thermally regenerable reusable component, likewise decomposed in a thermal treatment in which present overspray is thermally decomposed, with the result that, after the thermal treatment, only the reusable structure 112 of the filter module 40 remains behind. An example of a disposable component that may be mentioned is a filter element 90 consisting of a woven fleece which, during the thermal treatment, is decomposed together with the overspray and has to be replaced by a new woven fleece before the filter module 40 is functional again.

In a filter module 40 according to FIGS. 2 to 4, the housing frame structure 70, one or more housing wall segments 72, the collecting trough 82 or one or more filter elements 90 can either be a recyclable thermally regenerable reusable component or a thermally decomposable disposable component.

In a filter module according to FIG. 2, it is additionally possible for the carrier plate 100, one or both supporting walls 102 or one or more nonwoven mats to be either a recyclable thermally regenerable reusable component or a thermally decomposable disposable component.

In a filter module according to FIG. 3 or 4, it is additionally possible for the filter housing 108 or the receiving framework 110 to be either a recyclable thermally regenerable reusable component or a thermally decomposable disposable component.

In all exemplary embodiments, the module housing 66 as a whole, the filter unit 84 as a whole, the filter carrier structure 86 as a whole, the filter structure 88 as a whole or the filter device 106 as a whole can also be either recyclable and, for this purpose, thermally regenerable or be thermally decomposable. This means that, in this case, in each case all of the components of the module housing 66, of the filter unit 84, of the filter carrier structure 86, of the filter structure 88 or of the filter device 106 are either thermally regenerable reusable components or thermally decomposable disposable components.

In addition to the aforementioned components described by way of FIGS. 2 to 4, a filter module 40 can have further components which are not shown specifically. These include, in particular, supplementary or additional frame structures, walls, guideways, holders, flow-directing surfaces, collecting troughs, fastening parts, transport assemblies, stubs, connecting members and the like. Such further components can also be either thermally regenerable reusable components or thermally decomposable disposable components.

Thermally regenerable components can be produced in particular from metal, in particular from stainless steel, steel or steel sheet, or from ceramic materials. Where appropriate, load-bearing or supporting components, such as struts, frame parts or wall elements and the like, can be stabilized by structural measures, with the result that there does not occur any function-diminishing deformation of the components due to the thermal loading during the thermal treatment. For this purpose, it is possible, for example, for ribs or beads or the like to be provided in or on the components.

Thermally decomposable components can be produced from cellulose material, such as possibly treated paper and paperboard material, corrugated cardboard, cardboard with vertical corrugation, cardboard with a honeycomb structure or wraparound cardboard, but also from other materials such as, for example, MDF material or plastics, such as in particular polyethylene or polypropylene. Such materials can be able to be decomposed in a residue-free manner. Wood is also intended here to be understood as a cellulose material.

In the exemplary embodiment illustrated in FIG. 2, there is provision that all of the components, with the exception of the filter elements 90 in the form of nonwoven mats 92, are thermally regenerable reusable components and form the recyclable reusable structure 112, which can consequently be seen in FIG. 2A without the housing wall segments 72 and without the bottom part 80. Only the filter elements 90 in the form of the nonwoven mats 92 are thermally decomposable components and as such define the disposable structure 114.

If, in such a filter module 40, the limit loading with overspray is reached, said filter module is removed, in the above-described manner, from the facility region 36 and exchanged for an empty filter module 40. The laden filter module 40 is fed for thermal treatment in which the received overspray and the filter elements 90 are thermally decomposed. After the thermal treatment, the recyclable reusable structure 112 remains.

This reusable structure 112 is then equipped with usable filter elements 90, that is to say here with nonwoven mats 92, with the result that there is again formed an operational filter module 40 which can then again be introduced into the coating booth 10 in exchange for a laden filter module 40.

In the exemplary embodiments illustrated by way of FIGS. 3 and 4, there is provision that all of the components, with the exception of the filter device 106 as a whole, are thermally regenerable reusable components and form the recyclable reusable structure 112. The filter device 106 is thermally decomposable and defines the disposable structure 114, for which purpose all of the components which belong to the filter device 106 are thermally decomposable disposable components.

FIG. 5 schematically shows once again the coating facility 12, wherein the aforementioned pretreatment stations are designated all together by 116 and, moreover, by way of example, three coating booths 10 in the form of coating booths 10a, 10b, 10c for the application of a primer, a basecoat and a clearcoat are present through which the objects 14 to be coated run. Thereafter, the objects 14 pass into a drier 118 in which the coating is dried. What is to be understood by drying in the present case is both the driving of solvent out of a coating and the hardening of a coating, which can occur, for example, by a crosslinking reaction.

In the case of vehicle bodies 16, the vehicle is assembled after the coating has dried.

In the coating booths 10a, 10b, 10c there arise overspray-laden filter modules 40a, which are shown in FIG. 5 below the coating booths 10 and which, after reaching their limit loading, are removed from the coating booth 10 and exchanged for an empty filter module 40. Empty filter modules 40 are shown in FIG. 5 above the coating booths 10.

The laden filter modules 40a are fed for thermal treatment which is carried out in a thermal treatment apparatus 120. The thermal treatment that can be used is any type of heating by which a temperature is reached at which the overspray present in the laden filter modules 40a, and possibly a present disposable structure 114, are thermally decomposed. In general, the thermally decomposable constituent parts of the laden filter modules 40a can, for this purpose, be converted into the gaseous state or, where appropriate with a controlled oxygen supply, burnt to form ash.

For the thermal treatment, the laden filter modules 40a are exposed to temperatures between 200° C. and 900° C., possibly up to 1500° C., preferably between 300° C. and 900° C., more preferably between 400° C. and 900° C. and particularly preferably between 400° C. and 600° C. In particular, a pyrolysis comes into question as thermal treatment, for which purpose the thermal treatment apparatus 120 is a pyrolysis oven 122 having a pyrolysis burner, which is not specifically shown, which additionally comprises an afterburner designated by 123. In conventional pyrolysis, this occurs without oxygen being additionally supplied; where appropriate, however, oxygen can also be supplied.

Resulting from the laden filter modules 40a during the thermal treatment are residual materials 124 and hot exhaust gas 126 from the overspray and the disposable structure 114. In the case of the pyrolysis in the pyrolysis oven 122, there occur ash and residual materials 128 and first of all hot pyrolysis gas 130. The pyrolysis gas 130 is combustible and can for its part be used as a combustion gas for the pyrolysis burner (not shown). Before the pyrolysis process is started in such a way that the pyrolysis gas 130 can be used as combustion gas, the pyrolysis burner has to be supplied with a separate combustion gas. The recyclable reusable structure 112 remains of the filter module 40a after the thermal treatment. In FIG. 5 there is illustrated a variant of the filter module 40 in which only the receiving framework 110 according to FIG. 3 that is designed for two filter devices 106 serves as the recyclable reusable structure 114 and which consequently is available for reuse as a single component after the pyrolysis.

Such a recyclable reusable structure 112 is then completed again with a disposable structure 114 to form a filter module 40. For this purpose, in the exemplary embodiment described in FIG. 5, the reusable structure 112 in the form of the receiving framework 110 is equipped with two filter devices 106 and introduced into a module housing 66, with the result that an empty filter module 40 is formed which can be used thereafter for separating the overspray in one of the coating booths 10.

Before the reusable structure 112 is equipped with the supplementing disposable structure 114, the reusable structure 112 can be subjected to supplementary cleaning after the thermal treatment. Here, the reusable structure 112 or else individual thermally regenerable components of the reusable structure 112 can, for example, be shaken off by mechanical vibration, blown off with a cleaning gas, rinsed off with a cleaning medium, in particular a cleaning liquid, brushed off manually or in a partially or fully automated manner with a brushing tool, wiped off manually or in a partially or fully automated manner with a wiping means, or impinged by a material or particle jet.

The ash 128 can be deposited at a landfill site 132 and thus finally disposed of. The exhaust gas 126 or the pyrolysis gas 130 can be used as an energy source. For example, the exhaust gas 126 can be used as a heat source for a secondary device, for which purpose it can be fed to a heat exchanger in order to utilize its heat energy. This is generally shown at 133. For example, the exhaust gas 126 can serve as a heat source for a secondary device in the form of the drier 118 and be used to heat the atmosphere in the drier 118 to that temperature which is necessary for the drying operation.

Moreover, the pyrolysis gas 130 can be used for power generation, for which purpose, in FIG. 5, a combined heat and power plant 134 is shown by way of example. Before the pyrolysis gas 130 can be fed as combustion gas to a combustion engine at that location, it has to be cooled, where appropriate. The energy obtained in the combined heat and power plant 134 can then be used to operate the pretreatment stations 116 and/or the coating booths 10 and/or the drier 118. The energy obtained can also be used in some other way; this need not be in connection with the coating booth 12.

In a further modification illustrated in FIG. 5, the thermal energy which is obtained during the thermal treatment and which as a rule is present as heat energy of the exhaust gas 126 is stored in an energy store 136 and is then available at a later time. This stored energy can, for example, be used at a later time for the operation of the thermal treatment apparatus 120, specifically the pyrolysis oven 122. This takes account of the fact that usually a plurality of laden filter modules 40a are brought batchwise into the thermal treatment apparatus 120 and thermally treated there. Downtimes can occur between the thermal treatment of two batches; the energy can then be retrieved from the energy store 136 when it is required.

For exhaust gas 126 of up to temperatures of approximately 850° C., the thermal energy store 136 used can be, for example, a high-temperature energy store which uses sand or fine gravel as heat storage medium; such high-temperature energy stores are known on the market.

Moreover, the energy of the exhaust gas 126 can also be used for power generation, for which purpose, in FIG. 5, an ORC plant 138 is shown by way of example. What proceeds in an ORC plant is a so-called Organic Rankine Cycle by means of which power can be generated in a manner known per se.

The energy obtained there can then also be used for operating the pretreatment stations 116 and/or the coating booths 10 and/or the drier 118. The energy obtained can also be used in some other way; this likewise need not be in connection with the coating facility 12.

1. A filter module for separating overspray from overspray-laden booth air of coating facilities, in particular of painting facilities, having a module housing (66) in which a filter structure (88) is accommodated and which has a module inlet (74) and a module outlet (76) , wherein the filter module (40) is designed in such a way that, after reaching a limit loading with overspray, it is exchanged for an empty filter module (40),
characterized in that
the filter module (40) comprises a recyclable reusable structure (112) composed of one or more thermally regenerable reusable components, with the result that the filter module (40) is at least partially thermally regenerable.

2. The filter module as claimed in claim 1, characterized in that it comprises a disposable structure (114) composed of one or more thermally decomposable disposable components.

3. The filter module as claimed in claim 1 or 2, characterized in that one or more thermally regenerable reusable components or one or more thermally decomposable disposable components are present from the following group:
a) the module housing (66) as a whole or a housing frame structure (70) of the module housing (66) and/or one or more housing wall segments (72) of the module housing (66);
b) a collecting trough (82) for coating material which is separated in the filter module (40) and flows off downwardly;
c) the filter structure (88) as a whole or one or more filter elements (90) of the filter structure (88), in particular one or more nonwoven mats (92) of the filter structure (88);
d) a filter carrier structure (86) as a whole for the filter structure (88) or a carrier plate (100) for filter elements (90) of the filter carrier structure (86) and/or at least one supporting wall (102) of the filter carrier structure (86) and/or a receiving framework (110) for receiving a filter device (106) which comprises the filter structure (88);
e) the filter device (106) as a whole or a filter housing (108) of the filter device (106).

4. The filter module as claimed in claim 2 or 3, characterized in that one or more thermally decomposable disposable components are produced from one or more of the following materials: cellulose material, in particular possibly treated paper and paperboard material, corrugated cardboard, cardboard with vertical corrugation, cardboard with a honeycomb structure or wrap around cardboard, wood; MDF material; plastics material, in particular polyethylene or polypropylene.

5. The filter module as claimed in one of claims 1 to 4, characterized in that one or more thermally regenerable reusable components are produced from one or more of the following materials: metal or metal alloy, in particular stainless steel, steel or steel sheet; ceramic material.

6. A separating apparatus for separating overspray from overspray-laden booth air of coating facilities (12), in particular of painting facilities, having at least one filter module (40) through which overspray-laden booth air can be channeled and in which overspray is separated, characterized in that the at least one filter module (40) is a filter module as claimed in one of claims 1 to 5.

7. A coating facility for coating, in particular for painting, objects (14), in particular vehicle bodies (16), having
a) at least one coating booth (10) in which the objects (14) can have coating material applied to them and through which an air flow can be channeled that receives and removes occurring overspray of the coating material;
b) a separating apparatus to which this air flow can be fed and where a large part at least of the solids is separated from the overspray,
characterized in that
c) the separating apparatus is designed as claimed in claim 6.

8. The coating facility as claimed in claim 7, characterized in that a thermal treatment apparatus (120), in particular a pyrolysis oven (122), is present in which one or more laden filter modules (40) can be thermally treated in such a way that overspray is thermally decomposed.

9. A method for operating a coating facility (12) for coating, in particular for painting, objects (14), in particular vehicle bodies (16), wherein overspray from coating material occurs,
in which the overspray is received by an air flow and guided to a separating apparatus in the form of one or more filter modules (40) in which a large amount at least of the solids is separated from the overspray, wherein each filter module (40), after reaching a limit loading with overspray, is exchanged for an empty filter module (40),
characterized in that
one or more filter modules (40) as claimed in one of claims 1 to 5 are used, wherein a filter module (40), after reaching its limit loading with overspray as laden filter module (40a), is subjected, in a thermal treatment apparatus (120), to a thermal treatment in which the overspray is thermally decomposed.

10. The method as claimed in claim 9, characterized in that use is made of one or more filter modules (40) having a disposable structure (114) which is thermally decomposed during the thermal treatment, wherein the reusable structure (112) remaining after the thermal treatment is then completed again with a disposable structure (114) to form a filter module (40) which is used thereafter for separating overspray.

11. The method as claimed in claim 9 or 10, characterized in that the laden filter module (40a) is exposed to a temperature between 200° C. and 1500° C., preferably between 300° C. and 900° C., more preferably between 400° C. and 900° C. and particularly preferably between 400° C. and 600° C.

12. The method as claimed in one of claims 9 to 11, characterized in that the thermal treatment is a pyrolysis which is carried out in a pyrolysis oven (122) and in particular without separate supply of oxygen, wherein a pyrolysis gas (130) occurs.

13. The method as claimed in one of claims 9 to 12, characterized in that, during the thermal treatment, there occurs a hot exhaust gas (126) which is used as a heat source for a secondary device or for power generation.

14. The method as claimed in claim 13, characterized in that the secondary device is a drier (118) in which the coated objects (14) are dried and which comprises a heat exchanger to which the exhaust gas (126) is fed, and/or in that the pyrolysis gas (130) is fed for power generation to a combined heat and power plant (134).

15. The method as claimed in one of claims 9 to 14, in which the thermal energy obtained during the thermal treatment is stored in an energy store (136) and is possibly subsequently used in an ORC plant (138).

16. The method as claimed in one of claims 9 to 15, in which the energy of the exhaust gas (126) is used for power generation, for which purpose the exhaust gas (126) is fed in particular to an ORC plant (138).
